(19) United States
(12) Patent Application Publication
(10) Pub. No.: US 2008/0276669 A1
(43) Pub. Date: Nov. 13, 2008

(54) Doorknob With Lock Core

(76) Inventor: Mu-Lin Shen, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/747,340

(22) Filed: May 11, 2007

(51) Int. Cl. E05B 13/10

(52) U.S. Cl. 70/224

(57) ABSTRACT

A doorknob includes a hollow body and a spindle securely mounted in the body to turn therewith. An outer end portion of the spindle includes two diametrically opposed tongues each having an outer end. An end face plate is removably and rotatably received in a compartment in an open outer end of the body. The end face plate includes opposite inner and outer faces. The end face plate further includes a substantially 8-shaped hole extending from the inner face through the outer face. A projection extends perpendicularly from the inner face of the end face plate. The projection defines a space for receiving the outer ends of the spindle. A lock core is removably mounted in the 8-shaped hole of the end face plate and includes a portion received between the outer ends of the tongues of the spindle.

### BACKGROUND OF THE INVENTION

The present invention relates to a doorknob and, more particularly, to a door knob having an interchangeable lock core.

U.S. Pat. No. 4,052,868 discloses a doorknob structure including a neck portion, an intermediate portion of reduced wall thickness, and an outer end portion of solid section. The knob is rotatably mounted by the neck portion on a fixed hub supported by the side plate of a lock chassis. A tubular spindle or knob sleeve is rotatably mounted within the hub. The outer end of the knob is supported from the outer end of the knob sleeve by a locating ring. The locating ring has a central opening adapted to fit over the outer circumferential surfaces of the knob sleeve and has a pair of diametrically opposite tongues which engage in slots in the end of the knob sleeve. The locating ring also has four tabs offset from the plane of the ring, which engage in four axial slots in an axially-outward facing shoulder of a bore of the outer end portion. The central opening of the locating ring also has upper and lower extensions to provide clearance for a pin tumbler lobe of a key-removable core in either of its two orientations with respect to the knob sleeve. The outer end of the bore of the knob is closed by an end face member. In assembly, the end face member is firstly inserted into the bore to bring an end of a skirt of the end face member into engagement with a peripheral edge of the locating ring seated against the shoulder and lying coplanar with an inner portion of an undercut groove formed immediately in front of the shoulder. In this position, the corner of a beveled end of the skirt engages with a rounded corner of the locating ring, so that axial thrust on the skirt will tend to deflect the skirt outward. The circumferential edge of the locating ring lies opposite the undercut groove and partially closes a mouth of the undercut groove. but leaves an opening into which the skirt may move as it is deflected outward. The end face member is pressed inward from this position, and this causes the beveled edge of the skirt to be deflected and deformed outward into entrapment in the undercut groove. This secures the end face member and the locating ring in place in the knob.

The position of the end face member and the key-removable core can be adjusted to allow the doorknob to be utilized with either a right-handed door or a left-handed door. However, formation of the undercut groove in the doorknob requires troublesome machining by a lathe or extensive casting. Furthermore, the assembling procedure is complicated.

It is therefore a need in a doorknob that can be manufactured and assembled at low cost while allowing use with both right-handed and left-handed doors.

### BRIEF SUMMARY OF THE INVENTION

The present invention solves this need and other problems in the field of doorknobs having a lock core by providing, in a preferred form, a doorknob including a hollow body that includes an open outer end defining a compartment having an outer opening. A spindle is securely mounted in the body to turn therewith. The spindle includes two diametrically opposed slots in an outer end portion thereof, leaving two diametrically opposed tongues each having an outer end. An end face plate is removably and rotatably received in the compartment of the body. The end face plate includes an inner face, an outer face opposite to the inner face, and a periphery interconnected between the inner face and the outer face. The end face plate includes a substantially 8-shaped hole extending from the inner face through the outer face. A projection extends perpendicularly from the inner face of the end face plate. The projection defines a space for receiving the outer ends of the spindle. A lock core is mounted in the 8-shaped hole of the end face plate and includes a lug movable between a protruded position for securely engaging with the spindle and a retraced position allowing removal of the lock core from the end face plate. The lock core further includes a portion received between the outer ends of the tongues of the spindle

The body includes a recessed portion in the open outer end thereof. The recessed portion includes an end wall transverse to a longitudinal axis of the body and spaced from the outer opening. The recessed portion further includes a peripheral connecting wall interconnected between a periphery of the end wall and a periphery of the outer opening. The compartment is defined by the end wall and the peripheral connecting wall. In the most preferred form, the end wall is perpendicular to the longitudinal axis of the body, and the peripheral connecting wall is a conic wall extending at an acute inclination angle with respect to the longitudinal axis of the body. The periphery of the end face plate is conic and extends at an inclination angle the same as that of the peripheral connecting wall of the recessed portion. The conic periphery of the end face plate has decreasing diameter toward the inner face. The outer face of the end face plate has a size the same as that of the outer opening of the body. The end wall includes a central opening having upper and lower ends and two extensions extending outward from the upper and lower ends of the central opening, with the 8-shaped hole of the end face plate being aligned with the central opening and one of the extensions. An inner flange extends radially inward from an inner section of a perimeter defining the 8-shaped hole and perpendicular to the perimeter defining the 8-shaped hole. The lock core includes an enlarged front end abutting against the inner flange. The projection extends perpendicularly from the inner face of the end face plate along a lower portion of a peripheral edge of the 8-shaped hole. The projection includes two recessed portions on an inner face thereof and a protrusion between the recessed portions. The outer ends of the tongues of the spindle are respectively received in the recessed portions, and the protrusion is engaged in one of the slots of the spindle. Each slot includes an enlarged inner section to form a stepped portion on each tongue. The lug of the lock core in the protruded position is engaged with the stepped portion of one of the tongues to prevent disengagement of the lock core from the end face plate. The outer ends of the tongues forming the outer end portion of the spindle have a diameter smaller than that of an inner end of the spindle to increase structural strength at the outer end portion of the spindle.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a side view of a door lock with a doorknob according to the preferred teachings of the present invention.

FIG. 2 shows an enlarged view of a circled portion in FIG. 1.

FIG. 3 shows a partly exploded perspective view of the door lock of FIG. 1.

FIG. 4 shows a partly-cutaway perspective view of a portion of the doorknob of FIG. 1.

FIG. 5 is a sectional view taken along plane 5-5 in FIG. 1.

FIG. 6 is a sectional view similar to FIG. 5, with a lug of a lock core of the doorknob in a disengaged position allowing removal of the lock core from the doorknob.

FIG. 7 is a sectional view taken along plane 7-7 in FIG. 1.

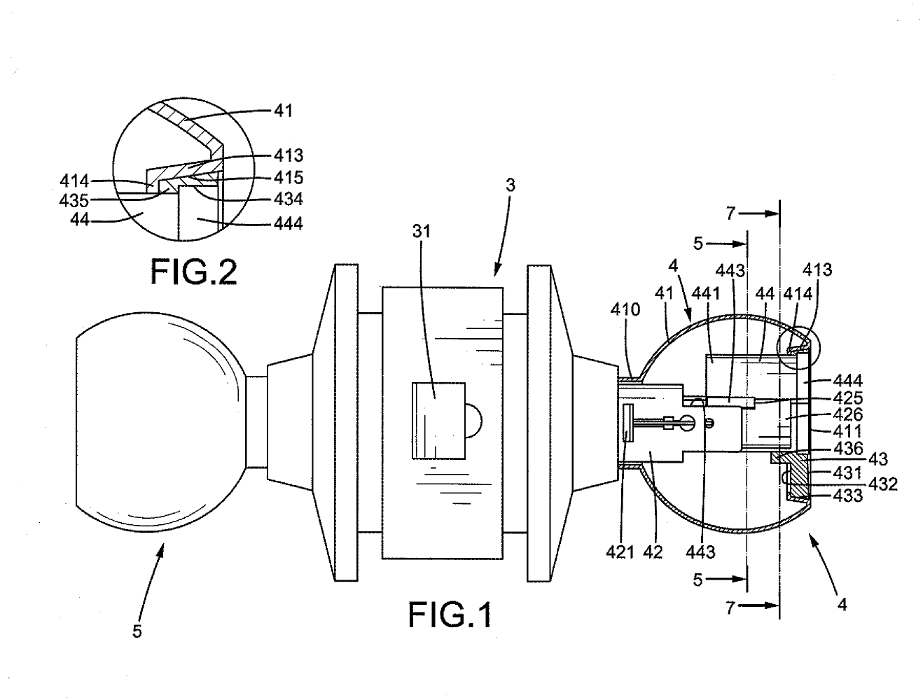

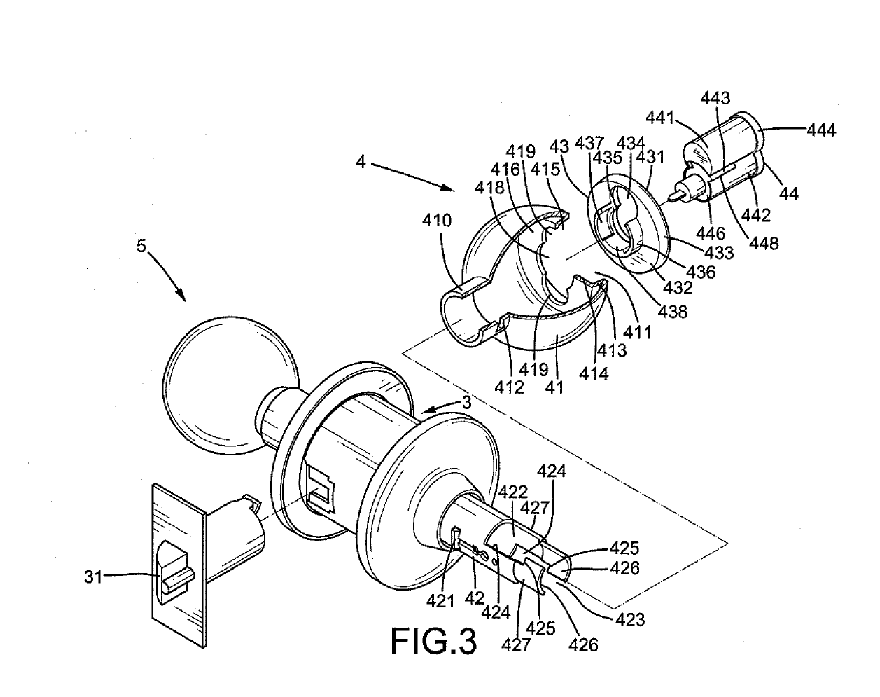

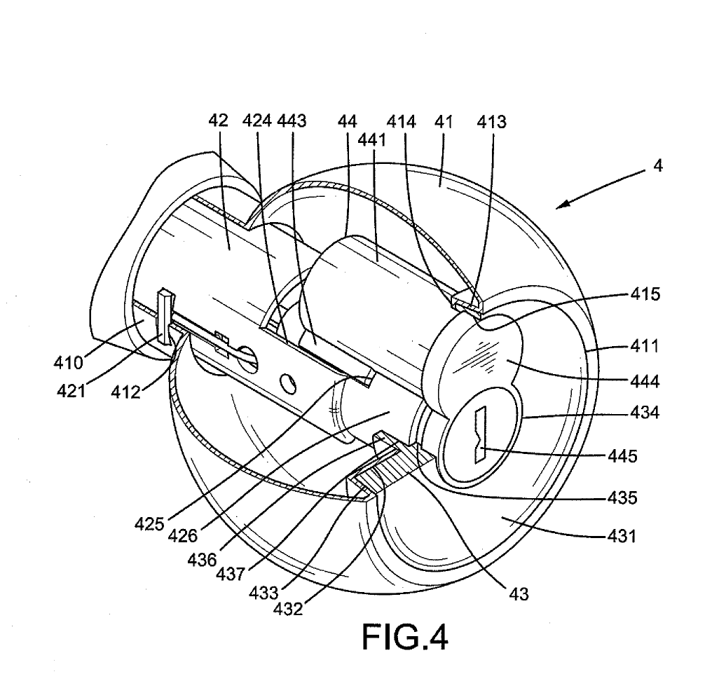

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “lower”, “upper”, “end”, “portion”, “section”, “longitudinal”, “radial”, “circumferential”, “inward”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A doorknob according to the preferred teachings of the present invention is shown in the drawings and generally designated 4. In the preferred form shown, the doorknob 4 is utilized as an outside knob of a door lock 1 including an inside knob 5 and a latch mechanism 3. Turning of either knob 4 or 5 causes retraction of a latch 31 of the latch mechanism 3.

According to the preferred form, the doorknob 4 includes a substantially hollow spherical body 41, a spindle 42 securely mounted in the body 41 to move therewith, an end face plate 43, and a lock core 44. The body 41 includes a neck portion 410 formed on an inner end thereof and having a slot 412. A recessed portion 416 is formed in an outer end of the body 41 and defines a compartment 415 having an outer opening 411 in an outer end face of the body 41. The opening 411 is circular in section and defined by a periphery. The recessed portion 416 further includes an end wall 414 transverse to the longitudinal axis of the body 41 and spaced from the opening 411. The end wall 414 includes a central opening 418 having upper and lower extensions 419 extending outward from upper and lower ends of the central opening 418. The recessed portion 416 further includes a peripheral connecting wall 413 interconnected between a periphery of the end wall 414 and the periphery of the opening 411, with the compartment 415 being defined by the end wall 414 and the peripheral connecting wall 413. The peripheral connecting wall 413 is a conic wall that extends at an inclination angle with respect to a longitudinal axis of the body 41. In the most preferred form, the inclination angle (or taper angle) is 30°, and the end wall 414 is perpendicular to the longitudinal axis of the body 41 and spaced from a spherical wall (not labeled) of the body 41.

In the preferred form shown, the spindle 42 is tubular and includes an inner end coupled with a retractor (not shown) connected to the latch 31. When the doorknob 4 is turned, the retractor is moved by the spindle 42 to retract the latch 31. The spindle 42 includes a keeper 421 mounted to an inner end thereof for engaging with the slot 412 to allow joint rotation of the spindle 42 and the doorknob 4. The spindle 42 further includes two diametrically opposed slots 422 and 423 in an outer end portion thereof, forming two diametrically opposed tongues 427 each having an outer end 426. Each slot 422, 423 has an enlarged, inner section 424 to provide a stepped portion 425 on each tongue 427. In the most preferred form shown, the outer ends 426 of the tongues 427 form the outer end of the spindle 42 having a diameter smaller than that of the inner end of the spindle 42. This increases the structural strength at the outer end of the spindle 42.

In the preferred form shown, the end face plate 43 is circular in section and includes an outer face 431, an inner face 432, and a conic periphery 433 interconnected between the outer face 431 and the inner face 432 and having decreasing diameter toward the inner face 432. The outer face 431 of the end face plate 43 has a size the same as the opening 411 of the body 41. The conic periphery 433 of the end face plate 43 extends at an inclination angle the same as that of the peripheral connecting wall 413 of the body 41. Thus, the end face plate 43 can be fittingly and rotatably engaged in the compartment 415 of the body 41. The end face plate 43 includes a substantially 8-shaped hole 434 extending from the inner face 432 through the outer face 431. An inner flange 435 extends radially inward from an inner section of a perimeter defining the 8-shaped hole 434 and perpendicular to the perimeter defining the 8-shaped hole 434. The inner flange 435 provides a seat against which the lock core 44 abuts. A projection 436 extends perpendicularly from the inner face 432 of the end face plate 43 along a lower portion of a peripheral edge of the 8-shaped hole 43, forming a substantially C-shaped wall on the inner face 432 of the end face plate 43. The projection 436 defines a space for receiving the outer ends 426 of the spindle 42. In the most preferred form shown, two recessed sections 437 are formed on an inner face of the projection 436 for respectively receiving the outer ends 426 of the tongues 427 of the spindle 42, with a protrusion 438 being formed between the recessed sections 437.

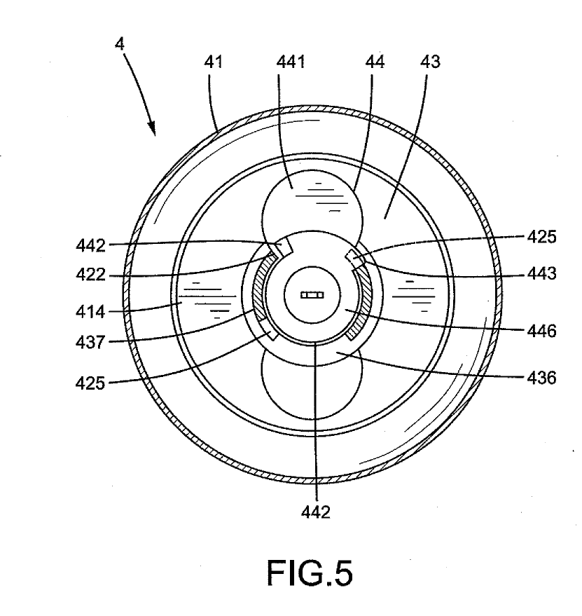

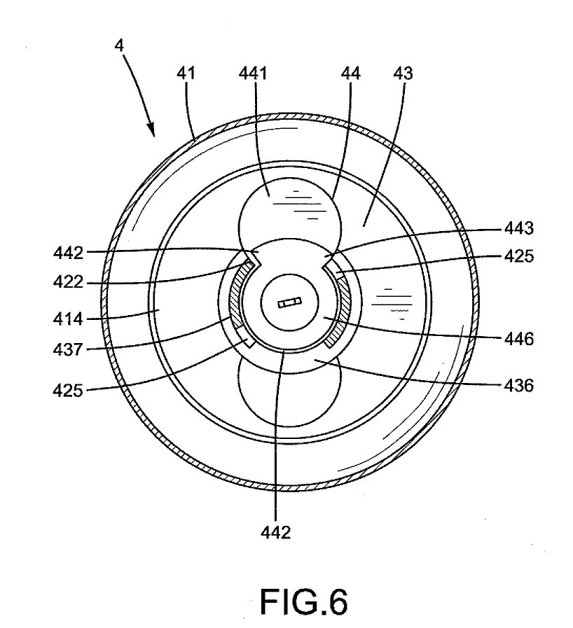

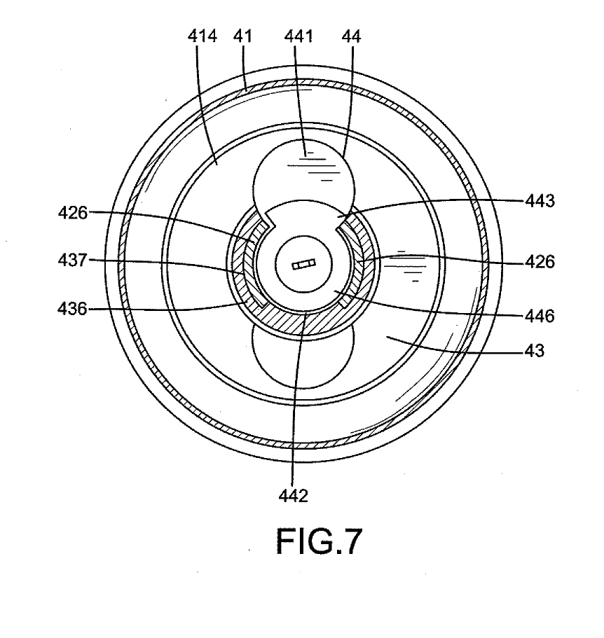

In the preferred form shown, the lock core 44 is substantially 8-shaped in section and removably received in the body 41. The lock core 44 includes an upper lobe 441, a lower lobe 442, and an enlarged front end 444. A cylinder 446 is received in the lower lobe 442 and has a keyway 445 in a front end thereof and a lug 443 on an outer periphery thereof. The lock core 44 further includes a slot 448 allowing the lug 443 to move between a protruded position outside the lock core 44 and a retracted position in the lock core 44. The lock core 44 is extended through the 8-shaped hole 434 of the end face plate, with the lower lobe 442 extending into the spindle 42 via the open, outer end of the spindle 42. A key can be inserted into the keyway 445 and turned to move the lug 443 to the protruded position to abut against one of the stepped portions 425 of the spindle 42 (see FIG. 5) or to the retracted position in the lock core 44 (see FIG. 6) allowing removal of the lock core 44 for replacement purposes. Another key can be inserted into the keyway 445 for locking/unlocking purposes. The lock core 44 can be of any types, including but not limited to commercially available interchangeable lock cores.

When the end face plate 43 is mounted in the compartment 415 of the body 41, the outer face 431 of the end face plate 43 is flush with the outer end face of the body 41 of the doorknob 4. The outer ends 426 of the spindle 42 are respectively and securely held in the recessed sections 437 of the projection 436 that extends through the central opening 418 of the end wall 414 of the body 41. The lock core 44 is extended through and engaged in the 8-shaped hole 434 of the end face plate 43, with a longitudinal axis of the lower lobe 442 of the lock core 44 being aligned with a longitudinal axis of the spindle 42. Specifically, the outer ends 426 of the spindle 42 are located between the lower lobe 442 of the lock core 44 and the projection 436 of the end face plate 43. The protrusion 438 of the projection 436 of the end face plate 43 is engaged in one of the slots 422 and 423 between the outer ends 426 of the spindle 42. Thus, the protrusion 438 of the end face plate 43 provides the spindle 42 with reinforced structure after assembly to resist torque imparted to the spindle 42. It is noted that the outer end of the spindle 42 (i.e., the outer ends 426 of the tongues 427) having a reduced diameter also increase the structural strength of the spindle 42. The enlarged front end 444 of the lock core 44 abuts against the inner flange 435 of the end face plate 43. In this case, a user can insert a key to turn the lug 443 to its protruded position to engage with one of the stepped portions 425 of the spindle 42. Thus, the lock core 44 and the end face plate 44 are securely mounted to the spindle 42, enhancing the structural strength of the doorknob 4.

The doorknob 4 can be mounted to either a right-handed door or a left-handed door. The upper and lower extensions 419 of the central opening 418 in the end wall 414 of the body 41 provides clearance for the upper lob 441 of the lock core 44 in either of upper and lower orientations with respect to the spindle 42. Specifically, the doorknob 4 is turned upside-down when it is mounted to a differently handed door. In this case, the lock core 42 can be removed, allowing subsequent manual removal of the end face plate 43 by inserting a finger into the 8-shaped hole 434 and pulling the end face plate 43 away from the body 41 of the doorknob 4. Next, the end face plate 43 is turned 180 degrees and reinserted into the compartment 415 of the body 41 of the doorknob 4, and the lock core 44 is reinstalled.

The body 41 of the doorknob 4 according to the preferred teachings of the present invention can be easily manufactured by drawing a metal tube at a low cost. Furthermore, the doorknob 4 according to the preferred teachings of the present invention can be easily assembled while having enhanced structural strength for the spindle 42.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A doorknob comprising:
a hollow body including an open outer end defining a compartment having an outer opening;
a spindle securely mounted in the body to turn therewith, with the spindle including two diametrically opposed slots in an outer end portion thereof, leaving two diametrically opposed tongues each having an outer end;
an end face plate removably and rotatably received in the compartment of the body, with the end face plate including an inner face, an outer face opposite to the inner face, and a periphery interconnected between the inner face and the outer face, with the end face plate including a substantially 8-shaped hole extending from the inner face through the outer face, with a projection extending perpendicularly from the inner face of the end face plate, with the projection defining a space for receiving the outer ends of the spindle; and
a lock core mounted in the 8-shaped hole of the end face plate and including a lug movable between a protruded position for securely engaging with the spindle and a retraced position allowing removal of the lock core from the end face plate, with the lock core further including a portion received between the outer ends of the tongues of the spindle.

2. The doorknob as claimed in claim 1, with the body including a recessed portion in the open outer end thereof with the recessed portion including an end wall transverse to a longitudinal axis of the body and spaced from the outer opening, with the recessed portion further including a peripheral connecting wall interconnected between a periphery of the end wall and a periphery of the outer opening, and with the compartment being defined by the end wall and the peripheral connecting wall.

3. The doorknob as claimed in claim 2, with the end wall being perpendicular to the longitudinal axis of the body, with the peripheral connecting wall being a conic wall extending at an acute inclination angle with respect to the longitudinal axis of the body, with the periphery of the end face plate being conic and extending at an inclination angle the same as that of the peripheral connecting wall of the recessed portion, with the conic periphery of the end face plate having decreasing diameter toward the inner face, and with the outer face of the end face plate having a size the same as that of the outer opening of the body.

4. The doorknob as claimed in claim 2, with the end wall including a central opening having upper and lower ends and two extensions extending outward from the upper and lower ends of the central opening, with the 8-shaped hole of the end face plate being aligned with the central opening and one of the extensions, with an inner flange extending radially inward from an inner section of a perimeter defining the 8-shaped hole and perpendicular to the perimeter defining the 8-shaped hole, and with the lock core including an enlarged front end abutting against the inner flange.

5. The doorknob as claimed in claim 1, with the projection extending perpendicularly from the inner face of the end face plate along a lower portion of a peripheral edge of the 8-shaped hole, with the projection including two recessed portions on an inner face thereof and a protrusion between the recessed portions, with the outer ends of the tongues of the spindle being respectively received in the recessed portions, and with the protrusion being engaged in one of the slots of the spindle.

6. The doorknob as claimed in claim 1, with each said slot including an enlarged inner section to form a stepped portion on each said tongue, and with the lug of the lock core in the protruded position being engaged with the stepped portion of one of the tongues to prevent disengagement of the lock core from the end face plate.

7. The doorknob as claimed in claim 1, with the outer ends of the tongues forming the outer end portion of the spindle having a diameter smaller than that of an inner end of the spindle to increase structural strength at the outer end portion of the spindle.
